(19) United States
(12) Patent Application Publication
(10) Pub. No.: US 2026/0023092 A1
(43) Pub. Date: Jan. 22, 2026

(54) TEACHING METHOD AND TEACHING AUXILIARY JIG

(71) Applicant: SHIMADZU CORPORATION, Kyoto (JP)

(72) Inventor: Tatsuya OBE, Kyoto (JP)

(73) Assignee: SHIMADZU CORPORATION, Kyoto (JP)

(21) Appl. No.: 19/254,811

(22) Filed: Jun. 30, 2025

(30) Foreign Application Priority Data
Jul. 17, 2024 (JP) 2024-113910

(51) Int. Cl. G01N 35/00; B25J 9/00

(52) U.S. Cl. CPC G01N 35/0099; B25J 9/0081; G01N 35/00584

(57) ABSTRACT

A teaching method for a sampling apparatus, the sampling apparatus comprising a three-dimensionally movable arm that holds a metal needle for performing sampling from a sample container in a vertical orientation, and a control unit that controls an operation of the arm, the method comprising: placing a magnet at a sampling position where a tip of the needle is to be placed during the sampling; after the placing, moving the arm by a user to a position where a magnetic force of the magnet acts on the needle; after the moving, positioning the tip of the needle with respect to the sampling position by using the magnetic force of the magnet; and after the positioning, storing, in the control unit, a position of the arm in a state where the tip of the needle is positioned at the sampling position.

### TECHNICAL FIELD

The present invention relates to a teaching method for a sampling apparatus and a teaching auxiliary jig.

### BACKGROUND ART

Sampling apparatuses such as autosamplers for liquid chromatographs and liquid handlers are devices that access a sample container placed at a predetermined position with a needle, aspirate a sample from a tip of the needle, and inject the aspirated sample into a mobile phase flowing toward a separation column (see Patent Literature 1).

In such sampling apparatuses, it is necessary to perform teaching to make a control unit learn a sampling position where the needle should be placed for sampling from the sample container, for example, during the initial setup of the apparatus or when a rack on which the sample containers are placed is replaced.

### PRIOR ART DOCUMENTS

### Patent Literature

Patent Literature 1: Japanese Unexamined Patent Application Publication No. 2023-000074

### SUMMARY OF THE INVENTION

### Problem to be Solved by the Invention

In the teaching of a sampling apparatus, it is common for an operator to perform position adjustment of a needle so that the tip of the needle comes to the sampling position while visually checking the position of the needle. However, visual teaching requires fine adjustment of the position of the needle in three directions (lateral, depth, and height directions) by operating a moving mechanism of the needle while checking the position of the needle, which imposes a heavy workload on the operator. In particular, it is difficult to check whether the tip of the needle is at the correct position for the positioning in the depth direction, and teaching is often performed while checking the position of the tip of the needle using a mirror. In addition, for a large sampling apparatus, the number of positions where teaching should be performed increases, which lengthens the time required for teaching.

The present invention has been made in view of the above problems, and an object of the present invention is to reduce the workload of an operator in teaching.

### Means for Solving the Problem

A teaching method according to the present invention is a teaching method for a sampling apparatus, the sampling apparatus comprising a three-dimensionally movable arm that holds a metal needle for performing sampling from a sample container in a vertical orientation, and a control unit that controls an operation of the arm, the method comprising:
placing a magnet at a sampling position where a tip of the needle is to be placed during the sampling;
after the placing, moving the arm by a user to a position where a magnetic force of the magnet acts on the needle;
after the moving, positioning the tip of the needle with respect to the sampling position by using the magnetic force of the magnet; and
after the positioning, storing, in the control unit, a position of the arm in a state where the tip of the needle is positioned at the sampling position.

A teaching auxiliary jig according to the present invention is a teaching auxiliary jig for an autosampler having a metal needle, the jig comprising: a main body part having an upper surface; and an attracting part placed at a sampling position on the upper surface, wherein the attracting part moves the needle that has approached the sampling position toward the sampling position.

### Effects of the Invention

According to the teaching method of the present invention, a magnet is placed at a sampling position where the tip of the needle is to be placed during sampling, the arm is moved by a user to a position where the magnetic force of the magnet acts on the needle, and the tip of the needle is positioned with respect to the sampling position by using the magnetic force of the magnet. This eliminates the need for fine adjustment while visually checking whether the tip of the needle is at the sampling position, thereby reducing the operator's workload during teaching.

According to the teaching auxiliary jig of the present invention, the jig includes the attracting part to be placed at the sampling position and is configured to move the needle that has approached the sampling position toward the sampling position, thereby reducing the operator's workload during teaching.

### BRIEF DESCRIPTION OF THE DRAWINGS

FIG. 1 is a schematic configuration diagram showing an example of the configuration of a sampling apparatus.

FIG. 2 is a flowchart for explaining an embodiment of a teaching method.

FIG. 3 is a diagram showing a state where a rack holding a container-type teaching auxiliary jig is placed in the sampling apparatus.

FIG. 4 is a diagram showing an example of a state where the tip of a needle is brought close to a magnet of the teaching auxiliary jig.

FIG. 5 is a diagram showing an example of a state where the tip of the needle is attracted to the magnet of the teaching auxiliary jig.

FIG. 6 is a diagram showing a state after fine adjustment of the arm position from the state of FIG. 5.

FIG. 7 is a diagram showing a state where a rack-type teaching auxiliary jig is placed in the sampling apparatus.

### DETAILED DESCRIPTION OF THE EMBODIMENTS

Hereinafter, an embodiment of a teaching method and a teaching auxiliary jig according to the present invention will be described with reference to the drawings.

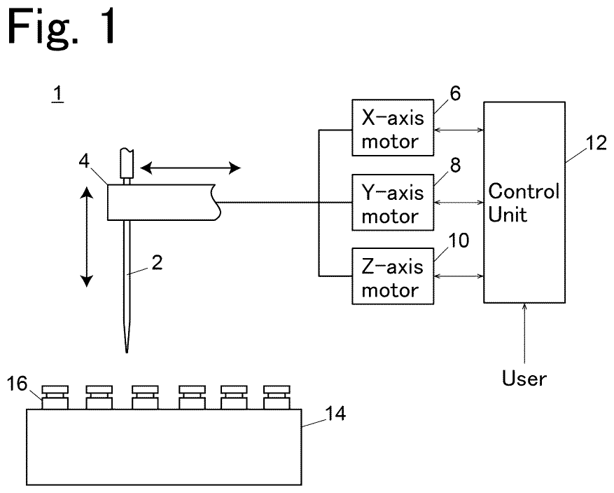

FIG. 1 shows an example of a sampling apparatus.

A sampling apparatus 1 includes a needle 2, an arm 4, an X-axis motor 6, a Y-axis motor 8, a Z-axis motor 10, and a control unit 12. A rack 14 for holding a plurality of sample containers 16 is placed at a predetermined position in the sampling apparatus 1.

The needle 2 is for performing sampling to aspirate a sample from the sample container 16. The needle 2 is held vertically by the arm 4 with its tip facing vertically downward. The arm 4 is moved in an X-axis direction and a Y-axis direction, which are orthogonal to each other in a horizontal plane, by the X-axis motor 6 and the Y-axis motor 8, and is moved in a Z-axis direction, which is a vertical direction, by the Z-axis motor 10. The X-axis motor 6, the Y-axis motor 8, and the Z-axis motor 10 are each a stepping motor.

Operations of the X-axis motor 6, the Y-axis motor 8, and the Z-axis motor 10 are controlled by the control unit 12. The control unit 12 stores each sampling position where the needle 2 should be placed to perform sampling from each sample container 16. During sampling, the control unit 12 controls the operations of the X-axis motor 6, the Y-axis motor 8, and the Z-axis motor 10 to move the needle 2 to the sampling position for performing sampling from a target sample container 16. Information on each sampling position is stored in the control unit 12 by teaching performed in advance. The control unit 12 is realized by a computer circuit including a CPU (Central Processing Unit) and an information storage memory.

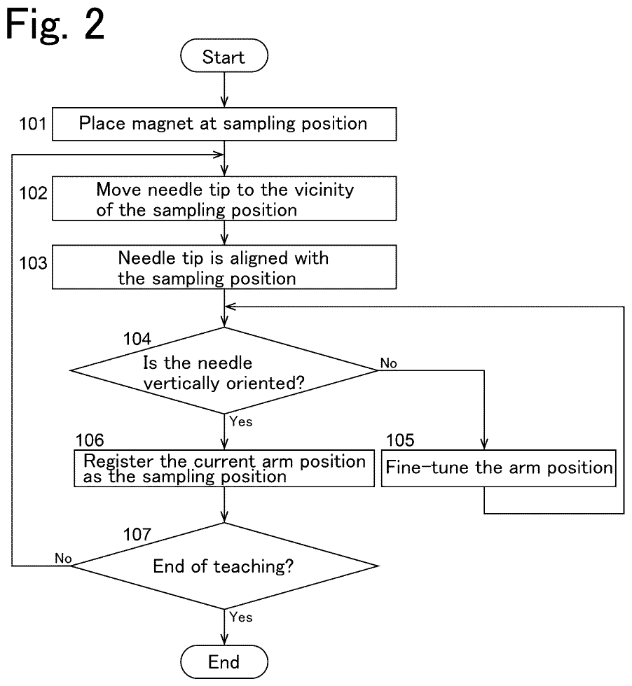

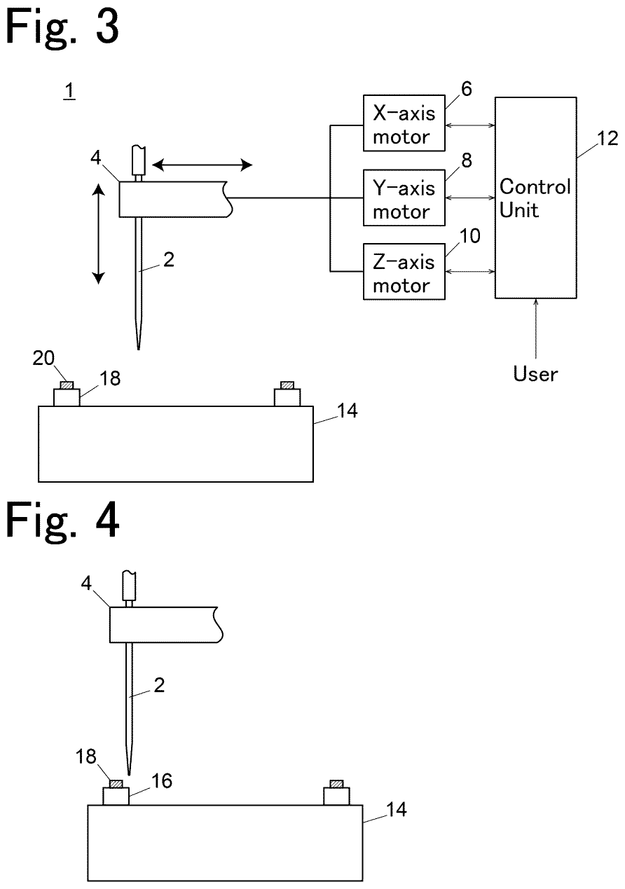

An embodiment of the teaching method will be described with reference to the flowchart of FIG. 2 and also FIGS. 3 to 7.

In the teaching, a teaching auxiliary jig is used. FIG. 3 shows an example using a container-type teaching auxiliary jig 18. As shown in FIG. 3, the container-type teaching auxiliary jig 18 is used by being held in the rack 14 instead of the sample container 16. The teaching auxiliary jig 18 includes a magnet 20 on its upper part and is configured such that the magnet 20 is placed at a sampling position when the rack 14 is placed at a predetermined position in the sampling apparatus 1. By placing the rack 14 holding the teaching auxiliary jig 18 at the predetermined position in the sampling apparatus 1, the magnet 20 is placed at the sampling position (Step 101).

It is preferable that the teaching auxiliary jig 18 is configured to be fixed to the rack 14 so that the teaching auxiliary jig 18 does not lift up when the needle 2 is brought close to the magnet 20.

Next, as shown in FIG. 4, the arm 4 is moved by an operator's hand so that the tip of the needle 2 approaches the magnet 20 placed at the sampling position and the magnetic force of the magnet 20 acts on the needle 2 (Step 102). At this time, it is preferable that excitation of the X-axis motor 6, the Y-axis motor 8, and the Z-axis motor 10 is turned off, so that the operator can freely move the arm 4 by hand, and the arm 4 can be moved by the magnetic force from the magnet 20 acting on the needle 2. When the tip of the needle 2 is brought close to the magnet 20, the tip of the needle 2 is attracted to the magnet 20 by the magnetic force of the magnet 20 and comes into contact with the magnet 20. As a result, the tip of the needle 2 is automatically positioned at the sampling position (Step 103).

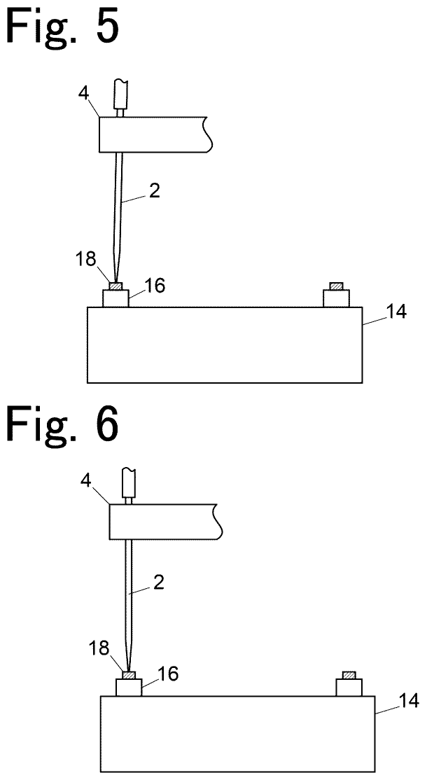

The operator checks whether the needle 2 is in a vertical orientation in a state where the tip of the needle 2 is in contact with the magnet 20 by magnetic force (Step 104). If the needle 2 is inclined from the vertical orientation as shown in FIG. 5 as a result of the tip of the needle 2 being attracted to the magnet 20 (Step 104: No), the operator fine-tunes the position of the arm 4 by hand (Step 105) and brings the needle 2 into the vertical orientation as shown in FIG. 6 (Step 104: Yes). The position coordinates of the arm 4 when the needle 2 is in the vertical orientation while the tip of the needle 2 is in contact with the magnet 20 are stored in the control unit 12 as the sampling position (Step 106).

If there are multiple sampling positions to be stored in the control unit 12, the above steps 101 to 106 are repeated for each sampling position (Step 107: No), and when the above steps are completed for all sampling positions, the teaching is finished (Step 107: Yes).

Here, the position coordinates of the arm 4 can be defined as the rotation angles (number of steps) of the X-axis motor 6, the Y-axis motor 8, and the Z-axis motor 10 from a home position of the arm 4. The X-axis motor 6, the Y-axis motor 8, and the Z-axis motor 10 are provided with counters for counting their respective numbers of steps. When the operator moves the arm 4 by hand during teaching, the numbers of steps of the X-axis motor 6, the Y-axis motor 8, and the Z-axis motor 10 corresponding to the moving distance in each direction are counted. The control unit 12 can read the position coordinates of the arm when the tip of the needle 2 is at the sampling position from the count numbers of the counters of the X-axis motor 6, the Y-axis motor 8, and the Z-axis motor 10.

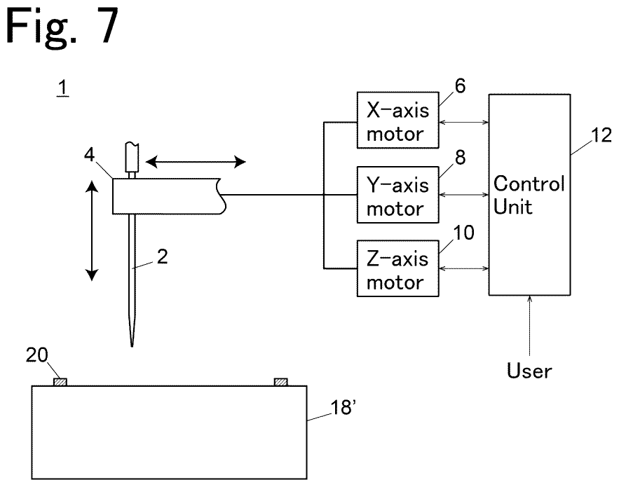

By the way, in the teaching, instead of the container-type teaching auxiliary jig 18 shown in FIG. 3, a rack-type teaching auxiliary jig 18′ as shown in FIG. 7 can be used. The rack-type teaching auxiliary jig 18′ has the same shape and size as the rack 14, and has a magnet 20 fixed at a specific position on its upper surface (a position where the sample container 16 is held in the rack 14). The rack-type teaching auxiliary jig 18′ can be used by being placed at a predetermined position in the sampling apparatus 1 instead of the rack 14.

The above-described embodiment is merely an example of the embodiment of the teaching method and the teaching auxiliary jig according to the present invention. Embodiments of the teaching method and the teaching auxiliary jig according to the present invention are as follows.

An embodiment of the teaching method according to the present invention is a teaching method for a sampling apparatus,
the sampling apparatus comprising a three-dimensionally movable arm that holds a metal needle for performing sampling from a sample container in a vertical orientation, and a control unit that controls an operation of the arm,
the teaching method comprising:
placing a magnet at a sampling position where a tip of the needle is to be placed during the sampling;
after the placing, causing a user to move the arm to a position where a magnetic force of the magnet acts on the needle;
after the moving, positioning the tip of the needle with respect to the sampling position by using the magnetic force of the magnet; and
after the positioning, storing, in the control unit, a position of the arm in a state where the tip of the needle is positioned at the sampling position.

In a first aspect of the above embodiment of the teaching method, the positioning comprises adjusting the position of the arm such that the needle is in the vertical orientation while the tip of the needle, attracted by the magnet, is in contact with the magnet.

In a second aspect of the above embodiment of the teaching method, the placing comprises placing a rack, to which the magnet is fixed, at a position where a rack for holding the sample container is to be placed. This second aspect can be combined with the first aspect.

An embodiment of a teaching auxiliary jig according to the present invention is a teaching auxiliary jig for an autosampler having a metal needle, the jig comprising: a main body part having an upper surface; and an attracting part placed at a sampling position on the upper surface, wherein the attracting part moves the needle that has approached the sampling position toward the sampling position.

A first aspect of the above embodiment of the teaching auxiliary jig is a container-type jig that is placed at a predetermined position in the sampling apparatus instead of the sample container.

A second aspect of the above embodiment of the teaching auxiliary jig is a rack-type jig that is placed at a predetermined position in the sampling apparatus instead of a rack for placing the sample container.

In a third aspect of the above embodiment of the teaching auxiliary jig, the attracting part is a magnet.

### DESCRIPTION OF REFERENCE NUMERALS

1 Sampling apparatus
2 Needle
4 Arm
6 X-axis motor
8 Y-axis motor
10 Z-axis motor
12 Control unit
14 Rack
16 Sample container
18 Container-type teaching auxiliary jig
18′ Rack-type teaching auxiliary jig
20 Magnet

What is claimed is:

1. A teaching method for a sampling apparatus, the sampling apparatus comprising:
a three-dimensionally movable arm that holds a metal needle for performing sampling from a sample container in a vertical orientation; and
a control unit that controls an operation of the arm,
the teaching method comprising:
placing a magnet at a sampling position where a tip of the needle is to be placed during the sampling;
after the placing, moving the arm by a user to a position where a magnetic force of the magnet acts on the needle;
after the moving, positioning the tip of the needle with respect to the sampling position by using the magnetic force of the magnet; and
after the positioning, storing, in the control unit, a position of the arm in a state where the tip of the needle is positioned at the sampling position.

2. The teaching method according to claim 1, wherein the positioning comprises adjusting the position of the arm such that the needle is in the vertical orientation while the tip of the needle, attracted by the magnet, is in contact with the magnet.

3. The teaching method according to claim 1, wherein the placing comprises placing a rack, to which the magnet is fixed, at a position where a rack for holding the sample container is to be placed.

4. A teaching auxiliary jig for an autosampler having a metal needle, the teaching auxiliary jig comprising:
a main body part having an upper surface; and
an attracting part placed at a sampling position on the upper surface,
wherein the attracting part moves the needle that has approached the sampling position toward the sampling position.

5. The teaching auxiliary jig according to claim 4, wherein the teaching auxiliary jig is a container-type jig that is placed at a predetermined position in the sampling apparatus instead of the sample container.

6. The teaching auxiliary jig according to claim 4, wherein the teaching auxiliary jig is a rack-type jig that is placed at a predetermined position in the sampling apparatus instead of a rack for placing the sample container.

7. The teaching auxiliary jig according to claim 4, wherein the attracting part is a magnet.
